(19) United States
(12) Patent Application Publication
(10) Pub. No.: US 2001/0012727 A1
(43) Pub. Date: Aug. 9, 2001

(54) BUSHING DEVICE FOR AN ELECTRICAL EQUIPMENT

(76) Inventors: ROBERTO MORLESIN, VILVOORDE (BE); IVAN FLORENT DE SCHRIJVER, BERLARE (BE)

Correspondence Address: SUGHRUE MION ZINN MACPEAK & SEAS PLLC, 2100 PENNSYLVANIA AVENUE N W, WASHINGTON, DC, 200373213

(21) Appl. No.: 09/412,586

(22) Filed: Oct. 5, 1999

(30) Foreign Application Priority Data
Oct. 6, 1998 (EP) 98402475.2

(51) Int. Cl. H02B 1/01; H01R 13/73; H01R 4/30; H01R 4/38

(52) U.S. Cl. 439/559; 439/544; 439/921; 439/801; 439/933

(57) ABSTRACT

A bushing device being either a “bushing” comprising an external standard interface cone on one side and a conical shape at the opposite side, or a “bushing well” having a single hollow conical shape comprising an internal standard interface cone. The bushing device is to be hermetically mounted in a hole of an electrical equipment, insulated with oil fluid or gas, and is foreseen of a metallic fixing flange having a diameter larger than the diameter of this hole. The bushing device is adapted to interconnect an electrical distribution cable external to the equipment with a device internal to the equipment. The equipment is for instance a transformer, a switchgear, a capacitor or a motor. The bushing device is made of an elastomeric material containing an anti-migratory additive, whilst the metallic fixing flange is preferably made of stainless steel adapted to be welded to the wall of the equipment.

The production phase of the elastomeric material is easy and fast, and the storage period for manufacturing after the mixing of the constituent products is relatively long. The performances of elastomeric material are similar to these of known epoxy bushing devices as to what concerns the cost of the material, isolation, and temperature change behavior. The anti-migratory additive is added to the elastomeric material for improving its permeability in order to make it compatible with the insulating medium. Preferably, the elastomeric material is a synthetic terpolymer of ethylene, propylene and diene (EPDM) improved with a synthetic copolymer of isobutylene and isoprene as anti-migratory additive.

The present invention relates to a bushing device to be hermetically mounted in a hole of a wall of an electrical equipment insulated with oil fluid or gas, the bushing device is adapted to interconnect an electrical distribution cable external to said equipment with a device internal to said equipment.

Such a bushing device is already known in the art, e.g. from the folder “Power Distribution Apparatus Bushing” (Cat. No. C-550-11) or “Bushings Wells” (Cat. No. C-510-11), both distributed by ELASTIMOLD®, Issue Date 8708 and available since Aug. 15, 1972. Therein, are presented bushing devices for in-oil and sulfur hexa fluoride (SF6) applications. These known bushing devices are cast with epoxy and have a stainless steel flange for welding or clamping to the equipment. The epoxy resin used therein is a thermosetting material chosen for its good performances concerning isolation, permeability and temperature change behavior, especially in a relatively aggressive environment as it is the case with the present oil or gas (SF6) application. Typical applications are transformers, switchgears, capacitor and motors.

The first mentioned known bushing device is constituted of a standardized interface cone on one side and a conical shape on the opposite side, it is generally known as “bushing”. The second mentioned known bushing device is a “bushing well” having a single hollow conical shape. The bushing device is foreseen of a fixing flange having a diameter that is larger than that of the hole in the equipment where the bushing device will be mounted. During the mounting operation, the conical shape is inserted in the hole, whilst the flange abuts against the sides of this hole. A sealing gasket needs to be inserted between the flange and the hole in order to ensure a good sealing of the equipment.

The epoxy resin, and more generally any thermosetting material, is also known for its fragility at relatively high temperatures, more particularly above the glass transition temperature (g 110° C.). However, during the welding of the stainless steel flange of the bushing to the wall of the equipment, the temperature may become excessively high (g 170° C.). A cooling is then necessary to avoid the fragilization of the epoxy.

Another problem with epoxy resin is that, once the constituent parts thereof are mixed together, the storage period is limited to a few hours, e.g. more or less 8 hours.

An object of the present invention is to provide a bushing device with improved performance and productivity with respect to that of the known epoxy bushing devices.

According to the invention, this object is achieved due to the fact that said bushing device is made of an elastomeric material containing an anti-migratory additive.

In this way, the elastomeric material advantageously replaces the epoxy resin of the known bushing devices. Indeed, elastomeric material allows a certain flexibility that ensures the tightness to the insulated equipment whereby an additional sealing gasket is no longer necessary. With respect to epoxy resin, elastomeric material resists to higher temperatures so that the cooling during a welding operation is also no longer necessary, the production phase is easier and faster, and the storage period for manufacturing after the mixing of the constituent products is dramatically longer. The performances of elastomeric material are further similar to these of epoxy resin as to what concerns the cost of the material, isolation, and temperature change behavior.

It is however to be noted that elastomeric material is known as having a high permeability. The permeability is the measure of the ease with which a liquid, vapor or gas (i.e. fluids) can pass through the material. The process is one of absorption and diffusion. The fluid dissolves into the material on one side thereof and then the dissolved material diffuses through to the opposite side, where evaporation takes place. Therefore, in the present invention, an anti-migratory additive is added to the elastomeric material in order to make it compatible with the insulating medium.

In a preferred embodiment, said elastomeric material is a synthetic terpolymer of ethylene, propylene and diene (EPDM) improved with a synthetic copolymer of isobutylene and isoprene as anti-migratory additive.

Contrarily to the above known epoxy resin, synthetic terpolymer of ethylene, propylene and diene, more generally called “EPDM”, may be recycled and is thus friendly for the environment. The synthetic copolymer of isobutylene and isoprene has been chosen for its dielectric and permeability properties.

Another characteristic feature of the present invention is that said elastomeric material comprises between 5 and 50 parts of said synthetic copolymer of isobutylene and isoprene.

The best performances are so obtained.

Preferably, said anti-migratory additive is a butyl rubber or a nitrile rubber.

Further characteristic features of the present bushing device are mentioned in the appended claims.

The above and other objects and features of the invention will become more apparent and the invention itself will be best understood by referring to the following description of an embodiment taken in conjunction with the accompanying drawings, in which:

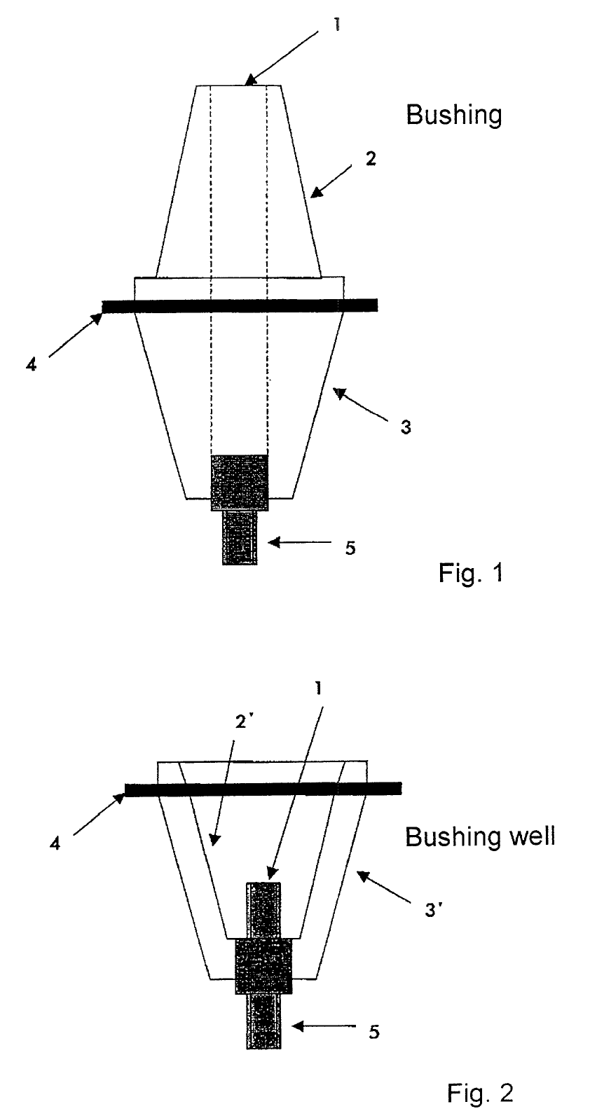

FIG. 1 is a “bushing” having the shape of two opposite cones according to the invention; and

FIG. 2 is a “bushing well” having the shape of a single hollow cone according to the invention.

The bushing device shown in FIG. 1 is more generally merely known as “bushing”, whilst the one shown in FIG. 2 is known as “bushing well”. Any of these bushing devices is used to be hermetically mounted in a hole of a wall of an electrical equipment insulated with oil fluid or gas, generally pressurized sulfur hexa-fluoride SF6. The electrical equipment is typically from the medium voltage range applications, e.g. from 10 kVolt up to 36 kVolt, such as transformers, switchgears, capacitors or motors.

The bushing device is adapted to interconnect an electrical distribution cable, external to the equipment, with a device, e.g. a switch, enclosed in the equipment that is a tank or a cubical filled with the insulated medium. One end of the bushing device is immersed in the insulated medium, whilst the other end is in the ambient air or designed to receive insulated connections.

The bushing device mainly comprises a metallic and electrically conductive internal rod 1 surrounded by a molded insulating layer. In the bushing of FIG. 1, this insulating layer has the shape of two cones 2, 3 of which the bases are joint. A metallic fixing flange 4 is foreseen at the base of the bottom cone 3 and extends outside this molded insulating layer. In the bushing well of FIG. 2, the insulating layer has the shape of a single hollow cone having an internal part 2′ and an external part 3′. A metallic fixing flange 4 is foreseen at the base of the cone and extends outside the external part 3′ of this molded insulating layer. The internal part 2′ has a shape that is complementary to that of the cone 2 at FIG. 1, both constituting a standardized interface cone for electrical applications as mentioned above.

In both cases, the diameter of the fixing flange 4 is larger than that of the hole in the equipment where the bushing device will be mounted. The fixing flange 4 is preferably made of stainless steel and abuts against the sides of the hole when the cone 3 or 3′ is inserted therein during the mounting operation. The stainless steel fixing flange 4 is then used for welding or clamping the bushing device to the equipment. If the bushing device is fixed to the equipment by device of fixing studs or bolts, holes (not shown) are provided in the flange 4 as well as at corresponding locations near to the hole of the equipment. In a preferred embodiment, the metallic flange 4 is welded to the wall of the equipment.

One end (top) of the internal rod 1 is either internally threaded (at the top of the bushing in FIG. 1) or externally threaded (inside the cone of the bushing well in FIG. 2), whilst the other end 5 thereof is externally threaded. Both ends are adapted to receive electrical connectors of the cable and of the equipment.

The insulating layer of the bushing device is a molded elastomeric material containing an anti-migratory additive. Preferably, the elastomeric material is a synthetic terpolymer of ethylene, propylene and diene, generally called “EPDM”. The anti-migratory additive is preferably a synthetic copolymer of isobutylene and isoprene, butyl rubber or nitrile rubber. It is added to the elastomeric material for improving its permeability in order to make it compatible with the insulating medium of the equipment. To this end, the elastomeric material should comprise between 5 and 50 parts of the anti-migratory additive.

While the principles of the invention have been described above in connection with specific apparatus, it is to be clearly understood that this description is made only by way of example and not as a limitation on the scope of the invention, as defined in the appended claims.

1. Bushing device to be hermetically mounted in a hole of a wall of an electrical equipment insulated with oil fluid or gas, the bushing device is adapted to interconnect an electrical distribution cable external to said equipment with a device internal to said equipment, characterized in that said bushing device is made of an elastomeric material containing an anti-migratory additive.

2. Bushing device according to claim 1, characterized in that said elastomeric material is a synthetic terpolymer of ethylene, propylene and diene (EPDM) improved with a synthetic copolymer of isobutylene and isoprene as anti-migratory additive.

3. Bushing device according to claim 2, characterized in that said elastomeric material (EPDM) comprises between 5 and 50 parts of said synthetic copolymer of isobutylene and isoprene.

4. Bushing device according to claim 1, characterized in that said anti-migratory additive is a butyl rubber.

5. Bushing device according to claim 1, characterized in that said anti-migratory additive is a nitrile rubber.

6. Bushing device according to claim 1, characterized in that said bushing device is a bushing having the shape of two oppositely mounted cones (2, 3) and comprising a fixing flange (4) located at the junction of the bases of said cones, said flange extending outside said cone and having a diameter larger than the diameter of said hole.

7. Bushing device according to claim 1, characterized in that said bushing device is a bushing well having the shape of a hollow cone (2′, 3′) and comprising a fixing flange (4) located at the base of said cone, said flange extending outside said cone and having a diameter larger than the diameter of said hole.

8. Bushing device according to any of the claims 6 or 7, characterized in that said fixing flange (4) is a metallic ring adapted to be welded to the wall of said equipment.
